(19) United States
(12) Patent Application Publication
(10) Pub. No.: US 2011/0020047 A1
(43) Pub. Date: Jan. 27, 2011

(54) SINGLE PACKAGE FOR MULTI-APPLICATOR WITH SINGLE OR MULTI-CHAMBERS

(76) Inventor: Tae Jin KIM, Vienna, VA (US)

Correspondence Address: LRK Patent Law Firm, 1952 Gallows Rd, Suite 200, Vienna, VA, 22182, US

(21) Appl. No.: 12/510,108

(22) Filed: Jul. 27, 2009

(51) Int. Cl. A45D 40/26; A46B 11/00; B43K 27/08; A45D 33/00

(52) U.S. Cl. 401/35; 401/121; 401/129; 401/130

(57) ABSTRACT

The present invention relates to multi-chambers having a unit for safely separating a cap, the multi chambers including: a chamber body that separates and receives one or more liquid; a plurality of brush rods that are immersed in each chamber of the chamber body; a cap that selectively takes out any one selected from the plurality of brush rods received in the case body; and a unit for safely separating a cap that is coupled with the lower part of the cap in an idle state and has its lower end screw-connected with the upper side of the case body.

The present invention according to the above configuration separates and receives one or more liquid into one chamber, selectively select brush rods immersed in each liquid using the cap coupled with the upper end of the chamber, and safely and smoothly separate and take out the brush rod from the chamber body using the unit for safely separating a cap without the splashing phenomenon, thereby making it possible to improve the feeling of use and the product quality.

In particular, the present invention has an effect of supplementing the structural vulnerability of the multi-chambers and stably using it, in the structure of the multi-chambers that is taken out in the state where the plurality of brush rods are mounted and the selected brush rod is eccentric from the center of the cap.

### TECHNICAL FIELD

The present invention relates to multi-chambers capable of separating and receiving one or more liquid into one chamber, immersing a brush rod in each chamber and selectively using it, and more specifically, to multi-chambers having a unit for safely separating a cap to prevent a splashing phenomenon when taking out a brush.

### BACKGROUND ART

Generally, in the case of wearing make-up by applying liquid-phase cosmetics such as lipstick, lip gloss, mascara, eyeliner, manicure, etc. using a brush, a brush rod in which a bundle of hairs is transplanted is mainly screw-connected with a chamber, so that the brush rod and the bundle of hairs are stored in the chamber to be able to be conveniently carried and when separating the cap as needed, the make-up can be worn by the brush on which a cosmetic solution is covered.

Two or more of the foregoing cosmetics is used together in some cases.

For example, in the case of wearing eye make-up, the mascara and eyeline are used together and in the case of wearing lip make-up, the lipstick and coating solution are used together, and in the case of wearing nail make-up, the manicure and coating solution are used together.

Therefore, the present applicant proposed a dual type cosmetic chamber that can receive two or more cosmetic solutions in one chamber for user's convenience in KR Laid-Open Patent No. 10-2008-01114484.

FIG. 1 is a perspective view illustrating a dual type cosmetic chamber of the related art, wherein an example where a selected brush rod 30 and a cap 20 are separated from a chamber body 10 is illustrated.

As shown in FIG. 1, the related art largely includes the chamber body 10 in which a cosmetic solution are received and the cap 20 that is coupled with the chamber body 10.

The chamber body 10 is detachably provided with a pair of brush rods 30 and 30′.

The pair of brush rods 30 and 30′ are selectively coupled by a holder (not shown) provided on a bottom surface of the cap 20 that is coupled with the chamber body 10 and is then drawn out together when the cap 20 is separated from the chamber body 10.

At this time, a user can wear make-up using a brush part 33 in the state where the cosmetic solution is covered on the brush part 33 of the drawn out brush rod 30.

An upper neck part 17 of the chamber body 10 is coupled with a wiper 50.

The wiper 50 compresses an outer diameter of the pair of brush rods 30 and 30′ made of a soft rubber material having flexibility and fixes its motion, prevents the cosmetic solution from being leaked, and when taking out the brush rods 30 and 30′, takes out the brush rods so that the cosmetic solution covered on the outer diameter of the brush rods is removed.

However, the related art as described above changes a pressure inside the chamber body in the process of taking out the brush rods 30 and 30′ from the chamber body 10.

In other words, a vacuum pressure corresponding to a volume where the brush rods 30 and 30′ are removed is formed inside the chamber body 10, which is hard to take out the brush rods 30 and 30′ as well as when forcibly taking out the brush rods, the vacuum pressure therein is removed at a time so that a splashing phenomenon of cosmetic solution together with a plosive such as ‘pop’ occurs.

This provides a very unpleasant experience to the user and degrades product quality.

Therefore, a need exists for a development of a chamber that improves a feeling of use by selectively mounting any brush rods 30 and 30′ to the holder (not shown) by rotating the cap 20 and safely separating the cap 20 and the brush rods 30 and 30′ from the chamber body 10 with a small force

### DISCLOSURE

### Technical Problem

The present invention proposes to solve the problems of the related art. It is an object of the present invention to provide multi-chambers that separate and receive one or more liquid into one chamber and is configured to selectively select brush rods immersed in each liquid using a cap coupled with an upper end of the chamber and then take out and use them and, and selectively use it, and more specifically, multi-chambers having a unit for safely separating a cap capable of safely and smoothly separating a brush from a chamber body without a splashing phenomenon.

### Technical Solution

In order to achieve the above objects, there is provided multi-chambers according to the present invention, including: a chamber body that separates and receives one or more liquid; a plurality of brush rods that are immersed in each chamber of the chamber body; a cap that selectively takes out any one selected from the plurality of brush rods received in the chamber body; and a unit for safely separating a cap that is connected with the lower part of the cap in an idle state and has its lower end screw-connected with the upper side of the chamber body. In the present invention, the inner diameter of the upper end of the unit for safely separating a cap is formed with an annular groove, the outer diameter of the lower end of the cap is formed with an annular projection coupled with the annular groove, the outer diameter of the lower end of the unit for safely separating a cap is formed with a male thread, and the inner diameter of the upper end of the chamber body is formed with a female thread connected with the male thread.

In the present invention, the inner diameter of the upper end of the unit for safely separating a cap is formed with an annular groove, the outer diameter of the lower end of the cap is formed with an annular projection coupled with the annular groove, the outer diameter of the lower end of the unit for safely separating a cap is formed with a male thread, and the outer diameter of the upper end of the chamber body is formed with a female thread connected with the male thread.

In the present invention, a plurality of chambers in the chamber body are partitioned by barrier ribs, the barrier ribs being radially disposed at the chamber body and the barrier ribs being disposed at a uniform or non-uniform interval.

The upper end of the chamber body is coupled with a wiper.

In brush rod of the present invention, a detachable head, which is detachably coupled with the cap, is formed at the upper side projected to the outside of the wiper, a connection rode is formed to be extended to the lower part of the detachable head, and an applying unit for applying liquid is formed at an end of the connection rod.

The cap is configured so that the outer diameter of the lower end thereof is formed with the annular projection that is coupled with the unit for safely separating a cap, the inner diameter of the lower end thereof is formed with a holder to be selectively connected with the detachable head of the brush rod, and the center of the inner diameter thereof is formed with a coupling shaft that contacts and supports the upper surface of the detachable head extended from the upper part.

At this time, the circumference of the upper end of the connection rod is coupled with a packing.

The brush rod is manufactured so that the upper end of the connection rod contacting the cone part of the wiper has a polygonal cross section and the rotation of the brush rod can be prevented.

As the applying unit, any one of applicators manufactured using natural hair, sponge, polymer, metal, etc., can be selectively used.

### Advantageous Effect

The multi-chambers having the unit for safely separating a cap according to the present invention separate and receive one or more liquid into one chamber, selectively select brush rods immersed in each liquid using the cap coupled with the upper end of the chamber, and safely and smoothly separate and take out the brush rod from the chamber body using the unit for safely separating a cap without the splashing phenomenon, thereby making it possible to improve the feeling of use and the product quality.

In particular, the present invention has an effect in supplementing the structural vulnerability of the multi-chambers and stably using it, in the structure of the multi-chambers that is taken out in the state where the plurality of brush rods are mounted and the selected brush rod is eccentric from the center of the cap.

### BRIEF DESCRIPTION OF THE DRAWINGS

FIG. 1 is a perspective view showing a dual type cosmetic chamber according to the related art;

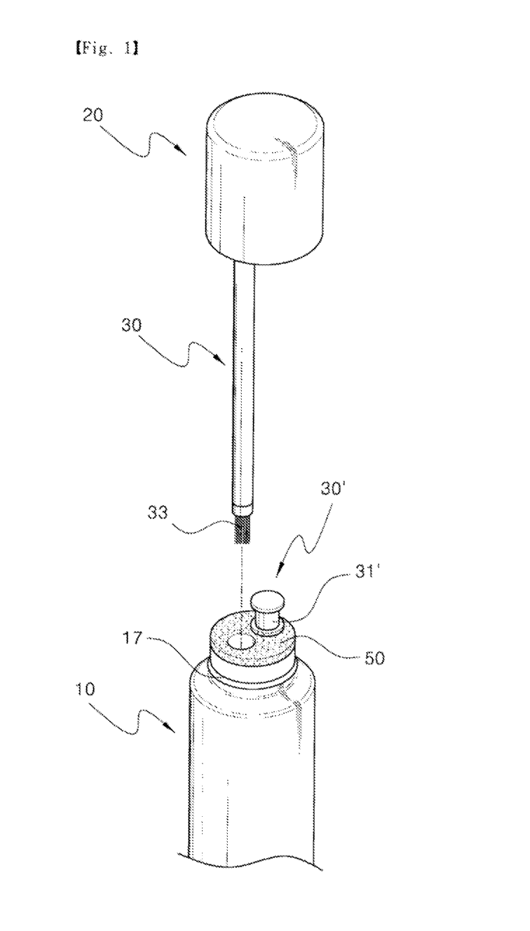

FIG. 2 is a front view showing a structure of multi-chambers having a unit for safely separating a cap according to a first embodiment of the present invention;

FIG. 3 is a cross-sectional view showing a state where a structure of multi-chambers having a unit for safely separating a cap according to a first embodiment of the present invention is exploded;

FIG. 4 is a cross-sectional view showing a state where a structure of multi-chambers having a unit for safely separating a cap according to a first embodiment of the present invention is coupled;

FIG. 5 is a cross-sectional view showing a state where a structure of multi-chambers having a unit for safely separating a cap according to a second embodiment of the present invention is coupled;

FIG. 6 is a front view showing a structure of multi-chambers having a unit for safely separating a cap according to a third embodiment of the present invention;

FIG. 7 is a cross-sectional view showing a state where a structure of multi-chambers having a unit for safely separating a cap according to a third embodiment of the present invention is exploded;

FIG. 8 is a cross-sectional view showing a state where a structure of multi-chambers having a unit for safely separating a cap according to a third embodiment of the present invention is coupled;

FIG. 9 is a cross-sectional view showing a state where a structure of multi-chambers having a unit for safely separating a cap according to a fourth embodiment of the present invention is coupled;

FIG. 10 is a cross-sectional view showing a state where a structure of multi-chambers having a unit for safely separating a cap according to a fifth embodiment of the present invention is coupled;

FIG. 11 is a cross-sectional view showing a state where a structure of multi-chambers having a unit for safely separating a cap according to a sixth embodiment of the present invention are coupled; and

FIG. 12 is a perspective view showing a holder structure that is applied to the fifth and sixth embodiment of the present invention.

### BEST MODE

Hereinafter, exemplary embodiments the present invention will be described in detail with reference to the accompanying drawings.

### First Embodiment

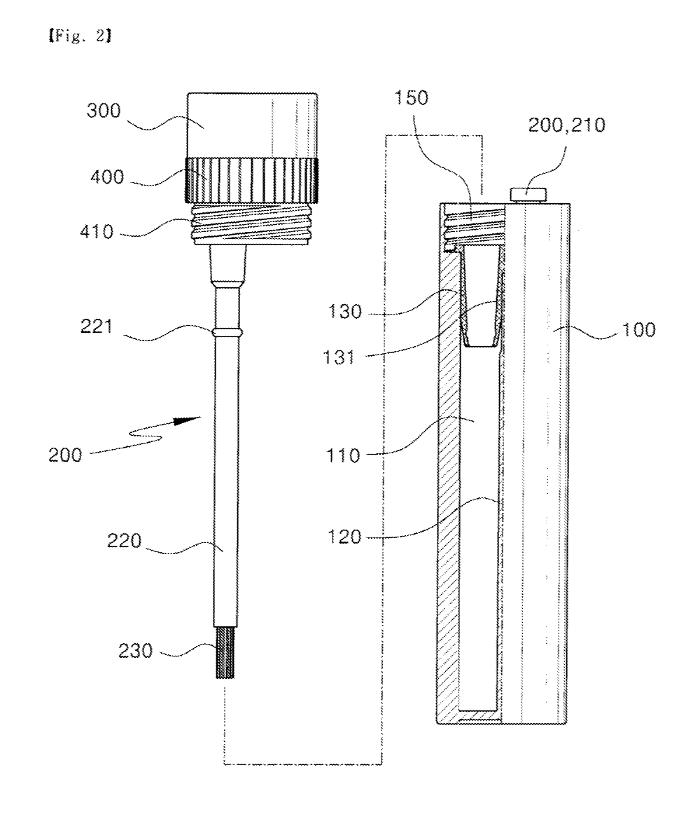

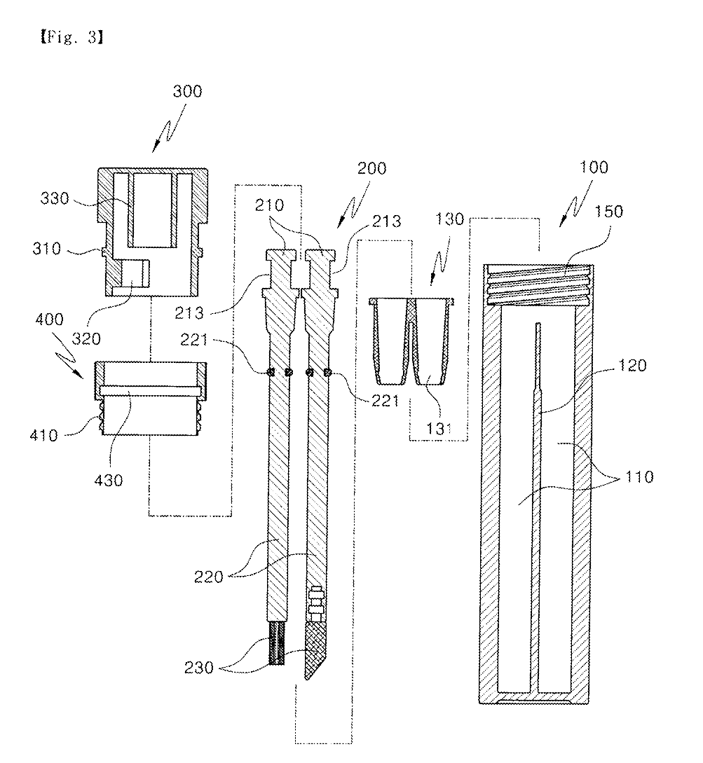

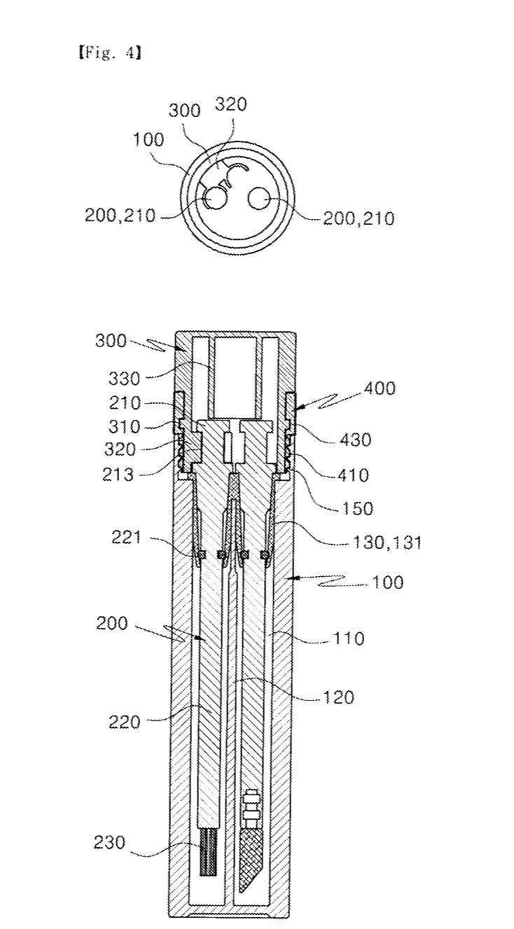

FIG. 2 is a front view showing a structure of multi-chambers having a unit for safely separating a cap according to a first embodiment of the present invention, FIG. 3 is a cross-sectional view showing an exploded state of the structure of the multi-chambers having the unit for safely separating a cap according to the first embodiment of the present invention, and FIG. 4 is a cross-sectional view showing a coupled state of the structure of the multi-chambers having the unit for safely separating a cap according to the first embodiment of the present invention.

As shown in the above drawings, the present invention includes: a chamber body 100 that separates and receives one or more liquid; a plurality of brush rods 200 that are immersed in each chamber 110 of the chamber body 100; a cap 300 that selectively takes out any one selected from the plurality of brush rods 200 received in the chamber body; and a unit 400 for safely separating a cap that is connected with the lower part of the cap 300 in an idle state and has its lower end screw-connected with the upper side of the chamber body 100.

In the chamber body 100 the plurality of chambers 110 are partitioned by barrier ribs 120. At this time, the barrier ribs 120 are radially disposed based on the center of the chamber body 100, wherein the barrier rib 120 may be disposed at a uniform or non-uniform interval and the space of the chamber 110 receiving liquid is defined according to the disposed interval.

The barrier rib 120 can be disposed from 0 to infinity and more preferably, is disposed between 0 and 10.

One or more liquid received in the chamber 110 can be used at the same time and the amount used may be the same or different according to its using methods or usages, respectively. At this time, when the aqueous solution is frequently used, the chamber 100 is designed to have a relatively large space. A neck part of the upper end of the chamber body 100 is coupled with a wiper 130, wherein the wiper 130 is made of a synthetic resin such as rubber, etc., to form a membrane between the chamber body 100 and the cap 300, thereby preventing the liquid from being leaked.

The wiper 130 forms cone parts 131 corresponding to each chamber 110, wherein the cone part 131 elastically compresses and supports an outer surface of the brush rod 200, such that a liquid covered on the outer surface of the brush rod is removed and taken out when taking out the brush rod 200.

This performs a role of preventing an excessive amount of liquid from being taken out at a time and evenly arranging applying units 230 such as a brush, etc., which are provided at the end of the brush rod 200.

At this time, the brush rod 200 can be manufactured so that an upper end of a connection rod 220 contacting the cone part 131 of the wiper 130 has a polygonal cross-section. The structure can prevent the brush rod 200 from randomly rotating.

Hereinafter, a configuration of the brush rod 200 according to the first embodiment will be described below in detail. The brush rod 200 performs a role of covering an appropriate amount of aqueous liquid in the chamber body 100 and applying it on an application surface.

In the brush rod 200, the detachable head 210, which is detachably coupled with the cap 300, is formed on the upper side projected to the outside of the wiper 130, a connection rod 220 is formed to be extended to the lower part of the detachable head 210, and an applying unit 230 for applying aqueous solution is formed at the end of the connection rod 220.

At this time, the detachable head 210 forms a key groove 212 in a band shape that is formed at the lower part thereof along a circumferential surface and the circumference of the upper end of the connection rod 220 is coupled with a packing 221, wherein the packing 221 is closely attached to the inner wall of the cone part 131 when the connection rod 220 penetrates through the cone part 131 of the wiper 130 to perform a function of pushing the aqueous solution into the chamber 110 and stably fix the connection rod 220 to the cone part 131 without shaking. As the applying unit 230, any one of applicators manufactured using natural hair, sponge, polymer, metal, etc. can be selectively used.

The brush rods 200 as described above are stored in a state where they are immersed in each chamber 110 of the chamber body 100 at normal times, but are selectively used to be alternately drawn out one by one by allowing a user to operate the cap 300 when wearing cosmetics.

The cap 300 according to the first embodiment of the present invention will be described below in more detail. The cap 300 is configured so that the outer diameter of the lower end thereof is formed with an annular projection 310 coupled with the unit 400 for safely separating a cap, the inner diameter of the lower end thereof is formed with a holder 320 to be selectively connected with the detachable head 210 of the brush rod 200, and the center of the inner diameter thereof is formed with a coupling shaft 330 that is extended from the upper part to support the upper surface of the detachable head 210.

The holder 320 has a structure where a clip part in “C” letter shape as shown in a plan view of FIG. 4 is formed left and right and is configured to rotate the cap 300 in a left and right direction to selectively mount the brush rod 200 in any one direction.

At this time, a coupling structure of the cap 300 and the brush rod 200 will be described below in more detail.

The coupling shaft 311 formed at the center of the cap 300 closely attaches and supports the upper surface of the detachable head 210 and the holder 320 formed in the inner diameter of the lower end of the cap 300 rotates along with the cap 300 such that it is coupled with the key groove 213 of the brush rod 200.

At this time, the coupling shaft 311 of the cap 300 simultaneously contacts the upper surfaces of the plurality of brush rods 200 and the holder 320 rotating left and right based on the coupling shaft 311 is coupled with a randomly selected brush rod 200 according to its rotational angle.

The coupling of the cap 300 and the brush rod 200 is made by the coupling structure as described above and the cap 300 is then separated from the chamber body 100 using the unit 400 for safely separating a cap.

The unit 400 for safely separating a cap according to the first embodiment of the present invention will be described below in more detail.

The unit 400 for safely separating a cap is configured so that it is connected to the lower part of the cap 300 in an idle state and its lower end is screw-connected with the upper side of the chamber body 100.

At this time, the inner diameter of the upper end of the unit 400 for safely separating a cap is formed with an annular groove 430 and the outer diameter of the lower end of the cap 300 is formed with the annular projection 310, such that a slip action between both members can be made.

Of course, the coupling structure of The annular groove 430 and the annular projection 310 may be formed to have a coupling structure opposite to each other.

The outer diameter of the lower end of the unit 400 for safely separating a cap is formed a male thread 410 and the inner diameter of the chamber body 100 is formed with a female thread 150 coupled with the male thread 410, such that the screw connection between both members can be made.

In other words, when the cap is separated from the chamber body 100 by rotating the unit 400 for safely separating a cap, the cap 300 is subjected to only a feed force in a vertical direction, not a rotational force by the slip action with the unit 400 for safely separating a cap.

The cap 300 is slowly raised by the rotational force of the unit 400 for safely separating a cap and the brush rod 200 coupled with the holder 320 of the cap 300 is slowly out of the wiper 130.

At this time, the brush rod 200 is slowly out of the wiper 130 by a uniform force and slowly releases a vacuum pressure inside the chamber body 100, such that the problem of the splashing of the aqueous solution therein can be solved.

As described above, the brush rod 200 in which the vacuum pressure is released using the unit 400 for safely separating a cap can be easily separated and used from the chamber body 100 by allowing the user to lift the cap 300 in a vertical direction using a small force.

### Second Embodiment

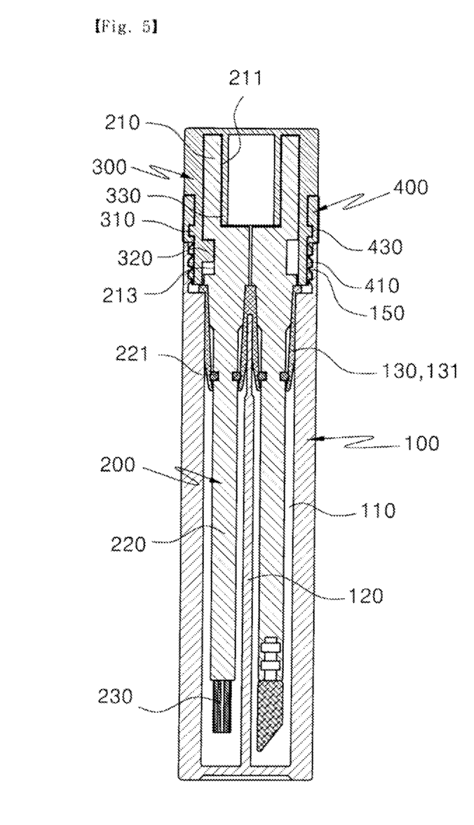

FIG. 5 is a cross-sectional view showing a state where a structure of multi-chambers having a unit for safely separating a cap according to a second embodiment of the present invention are coupled.

As shown in FIG. 5, a configuration of the second embodiment of the present invention is approximately the same as the configuration of the foregoing first embodiment; however, they have only a difference in the coupling structure of the cap 300 and the brush rod 200.

Therefore, the following description of the second embodiment of the present invention describes only the configuration and coupling structure of the cap 300 and the brush rod 200 and therefore, the description of the remaining configuration will be omitted.

The cap 300 according to the second embodiment of the present invention will be described below in more detail.

The cap 300 is configured so that the outer diameter of the lower end thereof is formed with an annular projection 310 coupled with the unit 400 for safely separating a cap, the inner diameter of the lower end thereof is formed with a holder 320 to be selectively coupled with the detachable head 210 of the brush rod 200, and the center of the inner diameter thereof is formed with a coupling shaft 330 that is extended from the upper part to support the upper surface of the detachable head 210.

At this time, the holder 320 may be manufactured in a projection shape that is extended from the inner diameter of the cap 300 to the center of the inner diameter thereof.

The configuration of the brush rods 200 according to the second embodiment of the present invention, which are selectively coupled by the cap 300, will be described below in more detail.

In the brush rod 200, the detachable head 210, which is detachably coupled with the cap 300, is formed on the upper side projected to the outside of the wiper 130, the connection rod 220 is formed to be extended to the lower part of the detachable head 210, and the applying unit 230 for applying aqueous solution is formed at the end of the connection rod 220.

At this time, the upper surface of the detachable head 210 is formed with a shaft coupling guide groove 211 and the lower part of the shaft coupling guide groove 211 is formed with the key groove 213 in a band shape formed along a circumferential surface.

The shaft coupling guide groove 211 is formed to be extended to the lower center of the detachable head 211 and the circumference of the coupling shaft 330 of the cap 300 is coupled to be surrounded by the shaft coupling guide groove 211, thereby achieving the more firmly coupling structure.

At this time, the detachable head 210 can be manufactured in a fan shape that conforms to the center of the chamber body 100 and the central angle thereof may be formed at a ratio of n/360° when the total number of brush rods received in the chamber body 100.

This corresponds to the case where the size of the chamber 100 receiving each brush rod 200 is the same and if the size of the chamber 110 is different, it may be formed in proportional to the size of each chamber 110.

In other words, it is preferable that in the detachable heads 210 of all the brush rods 200 received in the chamber body 100, the sum of central angles becomes 360°.

The circumference of the upper end of the connection rod 220 is coupled with the packing 221, wherein the packing 221 is closely attached to the inner wall of the cone part 131 when the connection rod 220 penetrates through the cone part 131 of the wiper 130 to perform a function of pushing the aqueous solution into the chamber 110 and stably fix the connection rod 220 to the cone part 131 without shaking.

As the applying unit 230, any one of applicators manufactured using natural hair, sponge, polymer, metal, etc. can be selectively used.

The plurality of brush rods 200 having the foregoing structure are stored in a state where they are immersed in each chamber 100 of the chamber body 100 at normal times. At this time, the detachable head 210 of each brush rod 200 has an arrangement of a circular state when viewed from a plane and each key groove 213 is connected along the circumference.

In other words, the coupling shaft 311 formed at the center of the cap 300 closely attaches and supports the upper surface of the detachable head 210 and the holder 320 formed in the inner diameter of the lower end part of the cap 300 rotates along with the cap 300 such that it is coupled with the key groove 213 of the brush rod 200.

At this time, the coupling shaft 311 of the cap 300 simultaneously contacts the upper surfaces of the plurality of brush rods 200 and the holder 320 rotating 360° based on the coupling shaft 311 randomly selects and couples the brush rod 200 and then operates the unit 400 for safely separating a cap, such that the brush rod is safely separated from the chamber body 100 without the splashing phenomenon.

The method of separating the cap 300 and the chamber body 100 using the unit 400 for safely separating a cap described in detail with reference to the first embodiment.

### Third Embodiment

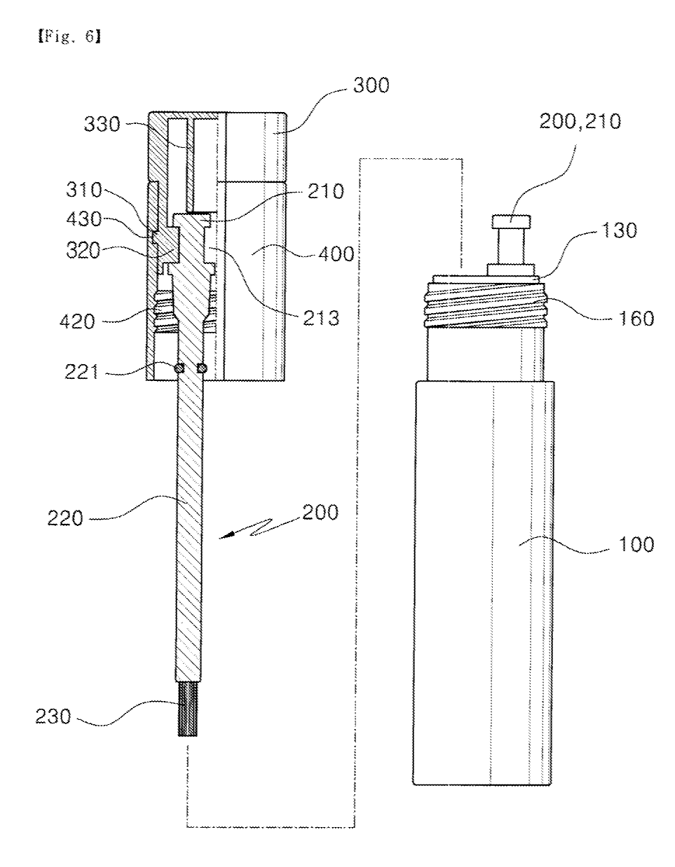

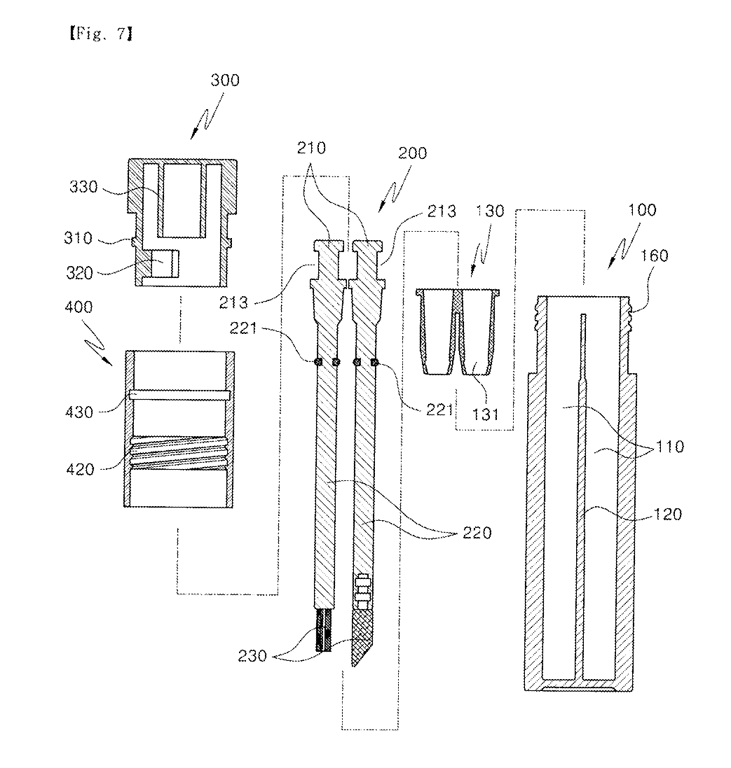

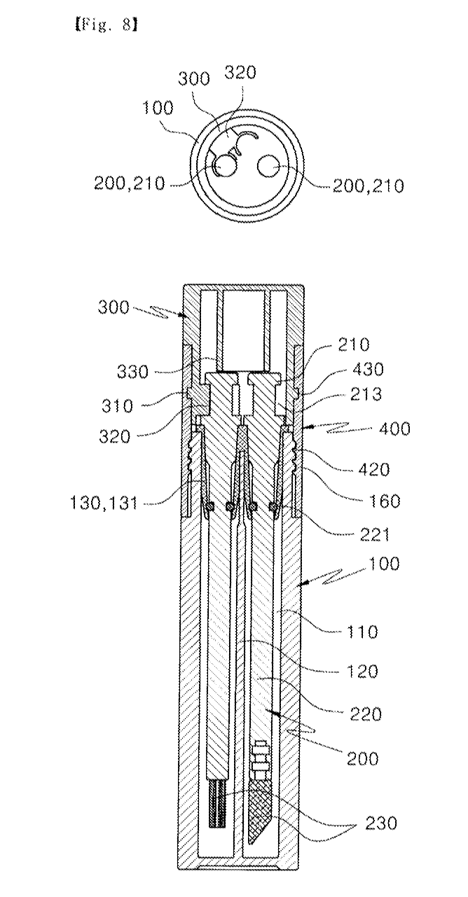

FIG. 6 is a front view showing a structure of multi-chambers having a unit for safely separating a cap according to a third embodiment of the present invention, FIG. 7 is a cross-sectional view showing an exploded state of the structure of the multi-chambers having the unit for safely separating a cap according to the third embodiment of the present invention, and FIG. 8 is a cross-sectional view showing a coupled state of the structure of the multi-chambers having the unit for safely separating a cap according to the third embodiment of the present invention.

As shown in the above drawings, the present invention includes: the chamber body 100 that separates and receives one or more liquid; the plurality of brush rods 200 that are immersed in each chamber 110 of the chamber body 100; the cap 300 that selectively takes out any one selected from the plurality of brush rods 200 received in the chamber body; and the unit 400 for safely separating a cap that is connected with the lower part of the cap 300 in an idle state and has its lower end screw-connected with the upper side of the chamber body 100

In the chamber body 100 the plurality of chambers 110 are partitioned by barrier ribs 120. At this time, the barrier ribs 120 are radially disposed based on the center of the chamber body 100, wherein the barrier rib 120 may be disposed at a uniform or non-uniform interval and the space of the chamber 110 receiving liquid is defined according to the disposed interval.

The barrier rib 120 can be disposed from 0 to infinity and more preferably, is disposed between 0 and 10.

One or more liquid received in the chamber 110 can be used at the same time and the amount used may be the same or different according to its using method or usage. At this time, when aqueous solution is frequently used, the chamber 100 is designed to have a relatively large space.

The neck part of the upper end of the chamber body 100 is coupled with the wiper 130, wherein the wiper 130 is made of a synthetic resin such as rubber, etc., to form a membrane between the chamber body 100 and the cap 300, thereby preventing the liquid from being leaked.

The wiper 130 forms the cone parts 131 corresponding to each chamber 110, wherein the cone part 131 elastically compresses and supports the outer surface of the brush rod 200, such that a liquid covered on the outer surface of the brush rod is removed and taken out when taking out the brush rod 200.

This performs a role of preventing an excessive amount of liquid from being taken out at a time and evenly arranging the applying units 230 such as a brush, etc., which are provided at the end of the brush rod 200.

At this time, the brush rod 200 can be manufactured so that the upper end of a connection rod 220 contacting the cone part 131 of the wiper 130 has a polygonal cross-section. The structure can prevent the brush rod 200 from randomly rotating.

Hereinafter, a configuration of the brush rod 200 according to the third embodiment will be described below in detail. The brush rod 200 performs a role of covering an appropriate amount of aqueous liquid in the chamber body 100 and applying it on an application surface.

In the brush rod 200, the detachable head 210, which is detachably connected with the cap 300, is formed on the upper side projected to the outside of the wiper 130, the connection rod 220 is formed to be extended to the lower part of the detachable head 210, and forms the applying unit 230 for applying aqueous solution is formed at the end of the connection rod 220.

At this time, the detachable head 210 forms the key groove 212 in a band shape that is formed at the lower part thereof along a circumferential surface and the circumference of the upper end of the connection rod 220 is connected with the packing 221, wherein the packing 221 is closely attached to the inner wall of the cone part 131 when the connection rod 220 penetrates through the cone part 131 of the wiper 130 to perform a function of pushing the aqueous solution into the chamber 110 and stably fix the connection rod 220 to the cone par 131 without shaking.

As the applying unit 230, any one of applicators manufactured using natural hair, sponge, polymer, metal, etc. can be selectively used.

The brush rods 200 as described above are stored in a state where they are immersed in each chamber 110 of the chamber body 100 at normal times, but are selectively used to be alternately drawn out one by one by allowing a user to operate the cap 300 when wearing cosmetics

The cap 300 according to the third embodiment of the present invention will be described below in more detail.

The cap 300 is configured so that the outer diameter of the lower end thereof is formed with an annular projection 310 coupled with the unit 400 for safely separating a cap, the inner diameter of the lower end thereof is formed with a holder 320 to be selectively coupled with the detachable head 210 of the brush rod 200, and the center of the inner diameter thereof is formed with the coupling shaft 330 that is extended from the upper part to support the upper surface of the detachable head 210.

The holder 320 has a structure where a clip part in “C” letter shape as shown in a plan view of FIG. 8 is formed left and right and is configured to rotate the cap 300 in a left and right direction to selectively mount the brush rod 200 in any one direction.

At this time, the coupling structure of the cap 300 and the brush rod 200 will be described below in more detail. The coupling shaft 311 formed at the center of the cap 300 closely attaches and supports the upper surface of the detachable head 210 and the holder 320 formed in the inner diameter of the lower end part of the cap 200 rotates along with the cap 300 such that it is coupled with the key groove 213 of the brush rod 200.

At this time, the coupling shaft 311 of the cap 300 simultaneously contacts the upper surfaces of the plurality of brush rods 200 and the holder 320 rotating left and right based on the coupling shaft 311 is coupled with a randomly selected brush rod 200 according to its rotational angle.

The coupling of the cap 300 and the brush rod 200 is made by the coupling structure as described above and the cap 300 is then separated from the chamber body 100 using the unit 400 for safely separating a cap.

The unit 400 for safely separating a cap according to the third embodiment of the present invention will be described below in more detail.

The unit 400 for safely separating a cap is configured so that it is connected to the lower part of the cap 300 in an idle state and its lower end is screw-connected with the upper side of the chamber body 100.

At this time, the inner diameter of the upper end of the unit 400 for safely separating a cap is formed with an annular groove 430 and the outer diameter of the lower end of the cap 300 is formed with the annular projection 310, such that the slip action between both members can be made.

Of course, the coupling structure of the annular groove 430 and the annular projection 310 may be formed to have the coupling structure opposite to each other.

The inner diameter of the lower end of the unit 400 for safely separating a cap is formed the female thread 420 and the inner diameter of the upper end of the chamber body 100 is formed with the male thread 160 coupled with the female thread 420, such that the screw connection between both members can be made.

In other words, when the cap is separated from the chamber body 100 by rotating the unit 400 for safely separating a cap, the cap 300 is subjected to only a feed force in a vertical direction, not a rotational force by the slip action with the unit 400 for safely separating a cap.

The cap 300 is slowly raised by the rotational force of the unit 400 for safely separating a cap and the brush rod 200 coupled with the holder 320 of the cap 300 is slowly out of the wiper 130.

At this time, the brush rod 200 is slowly out of the wiper 130 by a uniform force and releases a vacuum pressure inside the chamber body 100, such that the problem of the splashing of the aqueous solution therein can be solved.

As described above, the brush rod 200 in which the vacuum pressure is released using the unit 400 for safely separating a cap can be easily separated and used from the chamber body 100 by allowing the user to hold the cap 300.

### Fourth Embodiment

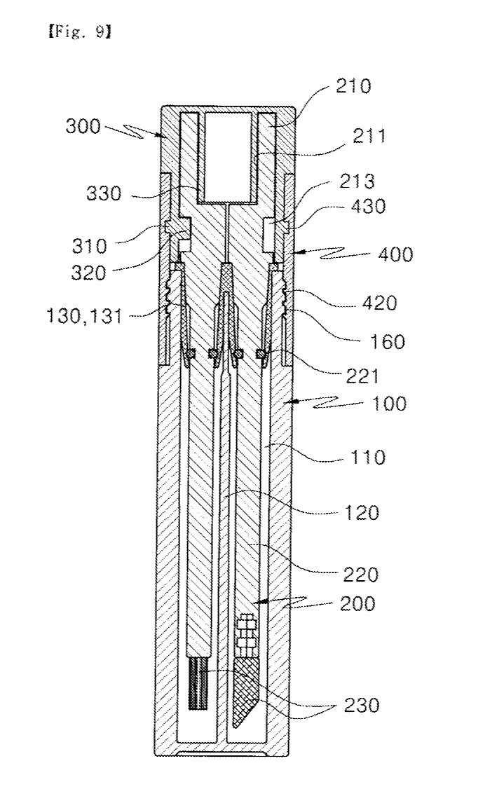

FIG. 9 is a cross-sectional view showing a state where a structure of multi-chambers having a unit for safely separating a cap according to a fourth embodiment of the present invention is coupled.

As shown in FIG. 9, a configuration of the fourth embodiment of the present invention is approximately the same as the configuration of the foregoing third embodiment; however, they have only a difference in the coupling structure of the cap 300 and the brush rod 200,

Therefore, the following description of the fourth embodiment of the present invention describes only the configuration and coupling structure of the cap 300 and the brush rod 200 and therefore, the description of the remaining configuration will be omitted.

The cap 300 according to the fourth embodiment of the present invention will be described below in more detail.

The cap 300 is configured so that the outer diameter of the lower end thereof is formed with the annular projection 310 coupled with the unit 400 for safely separating a cap, the inner diameter of the lower end thereof is formed with the holder 320 to be selectively coupled with the detachable head 210 of the brush rod 200, and the center of the inner diameter thereof is formed with the coupling shaft 330 that is extended from the upper part to support the upper surface of the detachable head 210.

At this time, the holder 320 may be manufactured in a projection shape that is extended from the inner diameter of the cap 300 to the center of the inner diameter thereof.

The configuration of the brush rods 200 according to the fourth embodiment of the present invention, which are selectively coupled by the cap 300, will be described below in more detail.

In the brush rod 200, the detachable head 210, which is detachably coupled with the cap 300, is formed on the upper side projected to the outside of the wiper 130, the connection rod 220 is formed to be extended to the lower part of the detachable head 210, and the applying unit 230 for applying aqueous solution is formed at the end of the connection rod 220

At this time, the upper surface of the detachable head 210 is formed with the shaft coupling guide groove 211 and the lower part of the shaft coupling guide groove 211 is formed with the key groove 213 in a band shape formed along a circumferential surface.

The shaft coupling guide groove 211 is formed to be extended to the lower center of the detachable head 211 and the circumference of the coupling shaft 330 of the cap 300 is coupled to be surrounded by the shaft coupling guide groove 211, thereby achieving the more firmly coupling structure.

At this time, the detachable head 210 an be manufactured in a fan shape that conforms to the center of the chamber body 100 and the central angle thereof may be formed at a ratio of n/360° when the total number of brush rods received in the chamber body 100.

This corresponds to the case where the size of the chamber 100 receiving each brush rod 200 is the same and if the size of the chamber 110 is different, it may be formed in proportional to the size of each chamber 110.

In other words, it is preferable that in the detachable heads 210 of all the brush rods 200 received in the chamber body 100, the sum of central angles becomes 360°.

The circumference of the upper end of the connection rod 220 is coupled with the packing 221, wherein the packing 221 is closely attached to the inner wall of the cone part 131 when the connection rod 220 penetrates through the cone part 131 of the wiper 130 to perform a function of pushing the aqueous solution into the chamber 110 and stably fix the connection rod 220 to the cone par 131 without shaking.

As the applying unit 230, any one of applicators manufactured using natural hair, sponge, polymer, metal, etc. can be selectively used.

The plurality of brush rods 200 having the foregoing structure are stored in a state where they are immersed in each chamber 100 of the chamber body 100 at normal times. At this time, the detachable head 210 of each brush rod 200 has an arrangement of a circular state when viewed from a plane and each key groove 213 is connected along the circumference.

In other words, the coupling shaft 311 formed at the center of the cap 300 closely attaches and supports the upper surface of the detachable head 210 and the holder 320 formed in the inner diameter of the lower end part of the cap 300 rotates along with the cap 300 such that it is coupled with the key groove 213 of the brush rod 200.

At this time, the coupling shaft 311 of the cap 300 simultaneously contacts the upper surfaces of the plurality of brush rods 200 and the holder 320 rotating 360° based on the coupling shaft 311 randomly selects and couples the brush rod 200 and then operates the unit 400 for safely separating a cap, such that the brush rod 200 is safely separated from the chamber body 100 without the splashing phenomenon.

The method of separating the cap 300 and the chamber body 100 using the unit 400 for safely separating a cap described in detail with reference to the third embodiment.

### Fifth and Sixth Embodiments

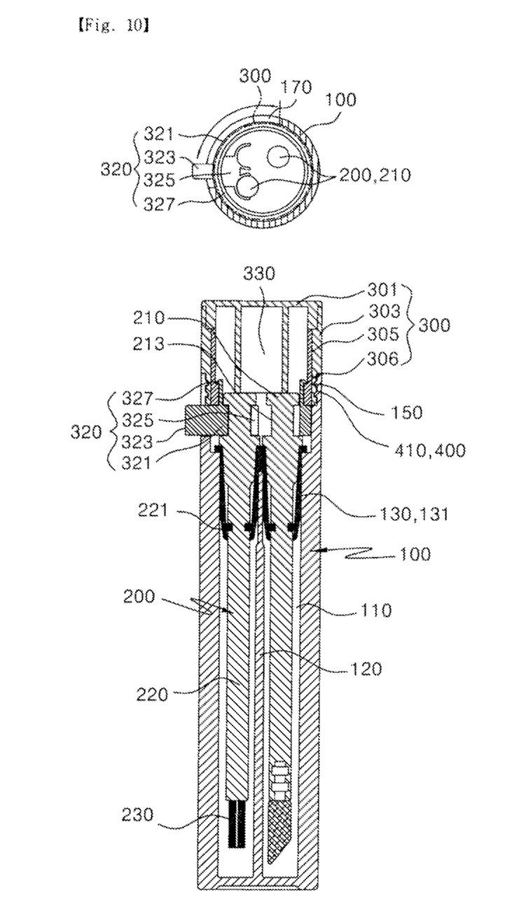

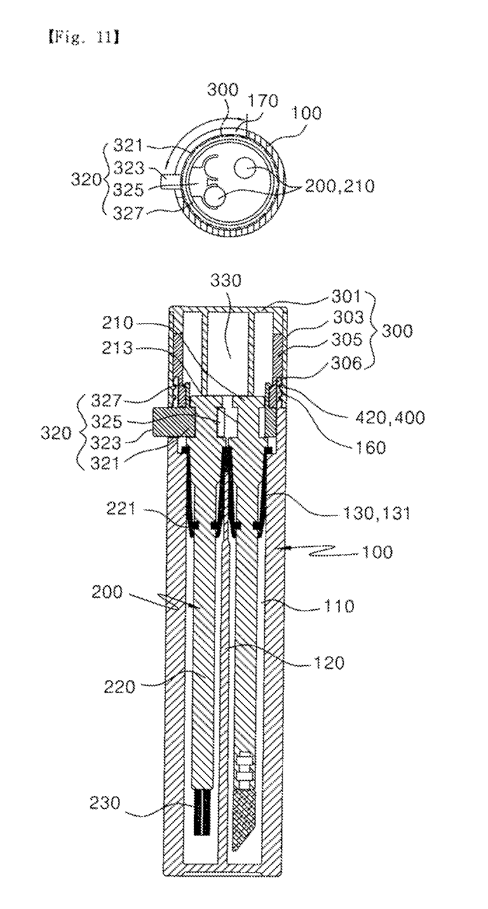

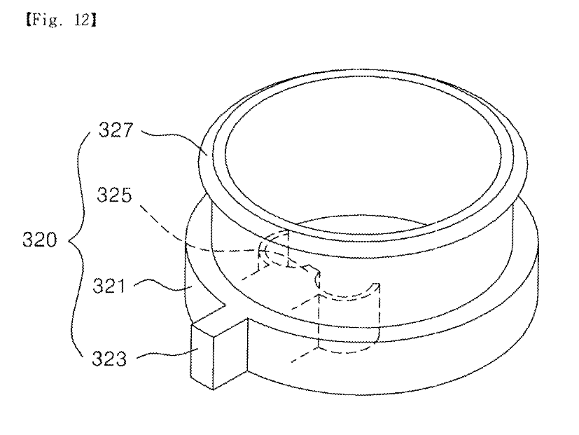

FIG. 10 is a cross-sectional view showing a state where a structure of multi-chambers having a unit for safely separating a cap according to a fifth embodiment is coupled, FIG. 11 is a cross-sectional view showing a state where a structure of multi-chambers having a unit for safely separating a cap according to a sixth embodiment is coupled, and FIG. 12 is a perspective view showing a holder structure applied to the fifth and sixth embodiments of the present invention.

As shown in the drawings, a configuration of the fifth and sixth embodiments of the present invention is approximately the same as the configuration of the foregoing first, second, third, and fourth embodiments; however, they have only a difference in the coupling structure of the cap 300 and the chamber body 100

Therefore, the following description of the fifth and sixth embodiments of the present invention describes only the configuration and coupling structure of the cap 300 and the chamber body 100 and therefore, the description of the remaining configuration will be omitted.

The configuration of the cap 300 according to the sixth embodiment of the present invention will be described below in more detail.

As shown in the drawings, the cap 300 is configured to include an upper end cap 301 where the coupling shaft 330, which contacts and supports the upper surface of the detachable head 210 at the center thereof, is formed to be extended to the lower part, an outer cap 303 that forms the lower outer circumference of the upper end cap 301 and has the unit 400 for safely separating a cap formed in the outer diameter or the inner diameter of the lower end thereof in a state where it can be screw-connected with the chamber body 100, and an inner cap 305 that is coupled with the holder 320 in an idle state, which is coupled with the inner diameter of the outer cap 303 to selectively couple the detachable head 210 of the brush rod 200 to the lower end thereof.

At this time, the unit 400 for safely separating a cap can be configured by forming the male thread 410 at the outer diameter of the lower end of the outer cap 303 and forming the female thread 150 coupled with the male thread 410 in the inner diameter of the upper end of the chamber body 100, as shown in FIG. 10.

In addition, the unit 400 for safely separating a cap can be configured by forming the male thread 420 at the inner diameter of the lower end of the outer cap 303 and forming the male thread 160 coupled with the female thread 410 in the inner diameter of the outer diameter of the chamber body 100.

As described above, reviewing the configuration of the holder 320 installed at the cap 300 in an idle state, the holder is configured to include a circular ring base 321, a handle 323 that is extendedly formed in an outer diameter of the ring base 321, a detachable arm 325 that is extendedly formed and rotated in the inner diameter of the ring base 321 to selectively couple the detachable head 210 of the brush rod 200, and an annular jaw part 327 that rotatably couples the ring base 321 to the inner cap 305 side.

At this time, the inner jaw 306 coupled to be opposite to the annular jaw part 327 is formed at the circumference of the inner diameter of the inner cap 305.

The handle 323 of the holder 320 is operated to projectedly extended to the outside of the camber body 100, wherein the chamber body 100 is formed with a rotational guide groove 170 so that the handle 323 can rotate left and right.

In the chamber body 100 the plurality of chambers 110 are partitioned by the barrier ribs 120 and the barrier ribs 120 are radially disposed at the chamber body 100, wherein the barrier ribs 120 can be disposed at a uniform or non-uniform interval and the upper end thereof is coupled with the wiper 130.

The configuration of the wiper 130 and the brush rod 200 coupled with the wiper 130 has the same configuration as the first, second, third, and fourth embodiments and therefore, the description thereof will be omitted.

The multi-chambers of the present invention configured as described above are usually used as the cosmetic chamber but can be applied to medicine, daily necessities, etc.

When the present invention is applied to the cosmetic chamber, the user can wear make-up by easily using two or more different cosmetic liquid by turns.

In addition, in the present invention, the cosmetic liquid received in the chamber body 100 is suitably set to be used at the time of shipping the product, such that the effort and trouble of the user to individually select cosmetics can be saved.

Further, the present invention can provide the multi-chambers that separate and receive two or more different cosmetic liquid into one chamber and is configured to selectively select the brush rods 200 immersed in each aqueous solution using the cap 300 coupled with the upper end of the chamber body and then take out and use them and, and take out and use them.

The present invention does not need to individually purchase various kinds of cosmetics and therefore, can save costs consumed to purchase cosmetics, and has an advantage in that it is convenient to store and carry it.

The cap 300 separated from the chamber body 100 is used as the handle of the brush rod 200 so that the use thereof is convenient, the chamber is stored in a stand state so that it is stable, the aqueous solution is naturally gathered in the bottom of the chamber body during the storage to maintain the state where the applying unit 230 of the brush rod 200 is immersed in the aqueous solution at all times so that the make-up time can be shorten and can maximally consume the residual quantity of the aqueous solution.

In addition, the chamber according to the present invention can receive two or more cosmetic liquid and rotates the cap 300 in 360° direction such that the selected brush rod 200 can be freely taken out and used, making it possible to wide the options of the user and freely widen or narrow the space of the chamber of cosmetic liquid. As a result, the present invention can distribute cosmetic liquid according to the frequency in use.

1. Multi-chambers having a unit for safely separating a cap, comprising:
a chamber body 100 that separates and receives one or more liquid;
a plurality of brush rods 200 that are immersed in each chamber 110 of the chamber body 100;
a cap 300 that selectively takes out any one selected from the plurality of brush rods 200 received in the chamber body; and
a unit 400 for safely separating a cap that is connected with the lower part of the cap 300 in an idle state and has its lower end screw-connected with the upper side of the chamber body 100.

2. The multi-chambers having a unit for safely separating a cap according to claim 1, wherein the inner diameter of the upper end of the unit 400 for safely separating a cap is formed with an annular groove 430, the outer diameter of the lower end of the cap 300 is formed with an annular projection 310 coupled with the annular groove 400, the outer diameter of the lower end of the unit 400 for safely separating a cap is formed with a male thread 410, and the inner diameter of the upper end of the chamber body 100 is formed with a female thread 150 connected with the male thread 410.

3. The multi-chambers having a unit for safely separating a cap according to claim 1, wherein the inner diameter of the upper end of the unit 400 for safely separating a cap is formed with an annular groove 430, the outer diameter of the lower end of the cap 300 is formed with an annular projection 310 coupled with the annular groove 400, the inner diameter of the lower end of the unit 400 for safely separating a cap is formed with a female thread 420, and the inner diameter of the upper end of the chamber body 100 is formed with a male thread 160 connected with the female thread 420.

4. The multi-chambers having a unit for safely separating a cap according to claim 1, wherein in the chamber body 100 the plurality of chambers 110 are partitioned by the barrier ribs 120 and the barrier ribs 120 are radially disposed at the chamber body 100, the barrier ribs 120 being disposed at a uniform or non-uniform interval.

5. The multi-chambers having a unit for safely separating a cap according to claim 1, wherein the upper end of the chamber body 100 is coupled with a wiper 130.

6. The multi-chambers having a unit for safely separating a cap according to claim 1, wherein in the brush rod 200, a detachable head 210, which is detachably coupled with the cap 300, is formed on the upper side projected to the outside of the wiper 130, a connection rod 220 is formed to be extended to the lower part of the detachable head 210, and an applying unit 230 for applying liquid is formed at the end of the connection rod 220.

7. The multi-chambers having a unit for safely separating a cap according to claim 1, wherein the cap 300 is configured so that the outer diameter of the lower end thereof is formed with the annular projection 310 coupled with the unit 400 for safely separating a cap, the inner diameter of the lower end thereof is formed with a holder 320 to be selectively coupled with the detachable head 210 of the brush rod 200, and the center of the inner diameter thereof is formed with the coupling shaft 330 that is extended from the upper part to support the upper surface of the detachable head 210.

8. The multi-chambers having a unit for safely separating a cap according to claim 6, wherein the circumference of the upper end of the connection rod 220 is coupled with a packing 221.

9. The multi-chambers having a unit for safely separating a cap according to claim 6, wherein the brush rod 200 is manufactured so that an upper end of a connection rod 220 contacting the cone part 131 of the wiper 130 has a polygonal cross-section, such that the rotation of the brush rod 200 is prevented.

10. The multi-chambers having a unit for safely separating a cap according to claim 6, wherein as the applying unit 230, any one of applicators manufactured using natural hair, sponge, polymer, metal is selectively used.

11. Multi-chambers having a unit for safely separating a cap, comprising:
a chamber body 100 that separates and receives one or more liquid;
a plurality of brush rods 200 that are immersed in each chamber 110 of the chamber body 100;
a cap 300 that installs a holder 320 to selectively take out any one selected from the plurality of brush rods 200 received in the chamber body in an idle state; and
a unit 400 for safely separating a cap that has its lower end screw-connected with the upper side of the chamber body 100.

12. The multi-chambers having a unit for safely separating a cap according to claim 11, wherein the cap 300 includes an upper end cap 301 where the coupling shaft 330, which contacts and supports the upper surface of the detachable head 210 at the center thereof, is formed to be extended to the lower part, an outer cap 303 that forms the lower outer circumference of the upper end cap 301 and has the unit 400 for safely separating a cap formed in the outer diameter or the inner diameter of the lower end thereof in a state where it can be screw-connected with the chamber body 100, and an inner cap 305 that is coupled with the holder 320 in an idle state, which is coupled with the inner diameter of the outer cap 303 to selectively couple the detachable head 210 of the brush rod 200 to the lower end thereof.

13. The multi-chambers having a unit for safely separating a cap according to claim 12, wherein the unit 400 for safely separating a cap is configured by forming the male thread 410 at the outer diameter of the lower end of the outer cap 303 and forming the female thread 150 coupled with the male thread 410 in the inner diameter of the upper end of the chamber body 100, as shown in FIG. 10.

14. The multi-chambers having a unit for safely separating a cap according to claim 12, wherein the unit 400 for safely separating a cap is configured by forming the female thread 420 in the inner diameter of the lower end of the outer cap 303 and forming the male thread 160 coupled with the female thread 420 in the outer diameter of the upper end of the chamber body 100.

15. The multi-chambers having a unit for safely separating a cap according to claim 12, wherein the holder 320 includes a circular ring base 321, a handle 323 that is extendedly formed in an outer diameter of the ring base 321, a detachable arm 325 that is extendedly formed and rotated in the inner diameter of the ring base 321 to selectively couple the detachable head 210 of the brush rod 200, and an annular jaw part 327 that rotatably couples the ring base 321 to the inner cap 305 side.

16. The multi-chambers having a unit for safely separating a cap according to claim 15, wherein The handle 323 of the holder 320 is projectedly extended to the outside of the camber body 100, the chamber body 100 being formed with a rotational guide groove 170 so that the handle 323 rotates left and right.

17. The multi-chambers having a unit for safely separating a cap according to claim 16, wherein in the chamber body 100 the plurality of chambers 110 are partitioned by the barrier ribs 120 and the barrier ribs 120 are radially disposed at the chamber body 100, the barrier ribs 120 being disposed at a uniform or non-uniform interval.

18. The multi-chambers having a unit for safely separating a cap according to claim 16, wherein the upper end of the chamber body 100 is coupled with a wiper 130.

19. The multi-chambers having a unit for safely separating a cap according to claim 2, wherein in the chamber body 100 the plurality of chambers 110 are partitioned by the barrier ribs 120 and the barrier ribs 120 are radially disposed at the chamber body 100, the barrier ribs 120 being disposed at a uniform or non-uniform interval.

20. The multi-chambers having a unit for safely separating a cap according to claim 3, wherein in the chamber body 100 the plurality of chambers 110 are partitioned by the barrier ribs 120 and the barrier ribs 120 are radially disposed at the chamber body 100, the barrier ribs 120 being disposed at a uniform or non-uniform interval.

21. The multi-chambers having a unit for safely separating a cap according to claim 2, wherein the upper end of the chamber body 100 is coupled with a wiper 130.

22. The multi-chambers having a unit for safely separating a cap according to claim 3, wherein the upper end of the chamber body 100 is coupled with a wiper 130.

23. The multi-chambers having a unit for safely separating a cap according to claim 2, wherein in the brush rod 200, a detachable head 210, which is detachably coupled with the cap 300, is formed on the upper side projected to the outside of the wiper 130, a connection rod 220 is formed to be extended to the lower part of the detachable head 210, and an applying unit 230 for applying liquid is formed at the end of the connection rod 220.

24. The multi-chambers having a unit for safely separating a cap according to claim 3, wherein in the brush rod 200, a detachable head 210, which is detachably coupled with the cap 300, is formed on the upper side projected to the outside of the wiper 130, a connection rod 220 is formed to be extended to the lower part of the detachable head 210, and an applying unit 230 for applying liquid is formed at the end of the connection rod 220.

25. The multi-chambers having a unit for safely separating a cap according to claim 2, wherein the cap 300 is configured so that the outer diameter of the lower end thereof is formed with the annular projection 310 coupled with the unit 400 for safely separating a cap, the inner diameter of the lower end thereof is formed with a holder 320 to be selectively coupled with the detachable head 210 of the brush rod 200, and the center of the inner diameter thereof is formed with the coupling shaft 330 that is extended from the upper part to support the upper surface of the detachable head 210.

26. The multi-chambers having a unit for safely separating a cap according to claim 3, wherein the cap 300 is configured so that the outer diameter of the lower end thereof is formed with the annular projection 310 coupled with the unit 400 for safely separating a cap, the inner diameter of the lower end thereof is formed with a holder 320 to be selectively coupled with the detachable head 210 of the brush rod 200, and the center of the inner diameter thereof is formed with the coupling shaft 330 that is extended from the upper part to support the upper surface of the detachable head 210.

27. The multi-chambers having a unit for safely separating a cap according to claim 23, wherein the circumference of the upper end of the connection rod 220 is coupled with a packing 221.

28. The multi-chambers having a unit for safely separating a cap according to claim 24, wherein the circumference of the upper end of the connection rod 220 is coupled with a packing 221.

29. The multi-chambers having a unit for safely separating a cap according to claim 23, wherein the brush rod 200 is manufactured so that an upper end of a connection rod 220 contacting the cone part 131 of the wiper 130 has a polygonal cross-section, such that the rotation of the brush rod 200 is prevented.

30. The multi-chambers having a unit for safely separating a cap according to claim 24, wherein the brush rod 200 is manufactured so that an upper end of a connection rod 220 contacting the cone part 131 of the wiper 130 has a polygonal cross-section, such that the rotation of the brush rod 200 is prevented.

31. The multi-chambers having a unit for safely separating a cap according to claim 23, wherein as the applying unit 230, any one of applicators manufactured using natural hair, sponge, polymer, metal is selectively used.

32. The multi-chambers having a unit for safely separating a cap according to claim 24, wherein as the applying unit 230, any one of applicators manufactured using natural hair, sponge, polymer, metal is selectively used.
